(19) United States
(12) Patent Application Publication
(10) Pub. No.: US 2006/0101633 A1
(43) Pub. Date: May 18, 2006

(54) Jig and method of manufacturing a display device using the same

(75) Inventor: Byoung-Hun Lee, Hwaseong-si (KR)

Correspondence Address: David W. Heid;MacPHERSON KWOK CHEN & HEID LLP, Suite 226, 1762 Technology Drive, San Jose, CA, 95110, US

(73) Assignee: Samsung Electronics Co., Ltd., Suwon-si (KR)

(21) Appl. No.: 11/256,564

(22) Filed: Oct. 21, 2005

(30) Foreign Application Priority Data
Oct. 21, 2004 (KR) 2004-84529

(51) Int. Cl. B25B 27/14; B23Q 3/00

(52) U.S. Cl. 29/464; 29/281.1

(57) ABSTRACT

A jig for manufacturing a display device is provided. In one embodiment, the jig includes a first hinge part for rotating a working plate to which a backlight assembly is fixed, and a second hinge part for rotating a cover to fix the backlight assembly to the working plate. A method of manufacturing a display device using the jig includes loading the backlight assembly on the working plate of the jig, installing a main panel on a main part of the backlight assembly, rotating the cover to fix the backlight assembly to the working plate, rotating the working plate, and installing a sub panel on a sub part of the backlight assembly. In various embodiments, use of the jig can provide improvements in assembly efficiency, reduced numbers of product defects, and improved production in the manufacture of display devices.

### CROSS-REFERENCE TO RELATED APPLICATIONS

This application claims priority to corresponding Korean Patent Application No. 2004-84529 filed in the Korean Intellectual Property Office, Republic of Korea, on Oct. 21, 2004, the disclosure of which is hereby incorporated by reference in its entirety.

### BACKGROUND OF THE INVENTION

1. Field of the Invention

The present invention relates to a jig, and a method of using the jig. More particularly, the present invention relates to a jig for use in manufacturing a display device, and a method of manufacturing a display device using the jig.

2. Description of the Related Art

As is generally known, display devices are used in connection with a variety of electronic devices such as cellular phones, digital cameras, notebook computers, monitors, and other devices. In particular, flat panel display devices such as liquid crystal displays (LCDs) have been widely used in various fields.

Recently, display devices capable of displaying images in two directions have been developed for use with various electronic devices. Such display devices include: a main panel for displaying a main image; a sub panel for displaying a time, a date, a receiving sensitivity, or other information; and a backlight assembly providing the main and sub panels with light.

These display devices can be assembled through the following process. The backlight assembly is joined to a jig, and then the main panel is installed on a main part of the backlight assembly. The backlight assembly on which the main panel is installed is disjoined from the jig. Then, the backlight assembly is joined again to the jig after turning the backlight assembly upside-down. The sub panel is then installed on a sub part of the backlight assembly. Before the main and sub panels are installed on the backlight assembly, the main and sub parts of the backlight assembly are inspected for proper on-off states and to determine whether impurities are present.

Typically, the assembly process is performed using a stationary jig. Unfortunately, the use of the stationary jig requires workers to handle the unfinished backlight assembly many times which can reduce production efficiency and lead to deterioration of a flexible circuit film or other parts of the backlight assembly.

### SUMMARY OF THE INVENTION

In one embodiment, the present invention provides a jig for improving assembly efficiency and reducing devective products, thereby improving production.

In another embodiment, the present invention provides a method of manufacturing a display device using the above-mentioned jig.

In another embodiment of the present invention, a jig for manufacturing a display device includes a stage, a first hinge part, a working plate, a second hinge part and a cover. The first hinge part is disposed over the stage and is substantially parallel with the stage. The working plate is joined to the first hinge part and includes a receiving part to receive an object. The second hinge part is at a side of the working plate. The second hinge part is substantially parallel with the working plate. The cover is joined to the second hinge part. The working plate may further include a third hinge part, and a supporting member joined to the third hinge part to be rotated with respect to the third hinge part. The working plate may further include a power applying part for applying power to the object.

In another embodiment of the present invention, a method of manufacturing a display device using a jig includes loading a backlight assembly onto a working plate of the jig, installing a main panel on a main part of the backlight assembly, rotating a cover joined to the working plate to fix the backlight assembly to the working plate, rotating the working plate, and installing a sub panel on a sub part of the backlight assembly. The method may further include inspecting the backlight assembly loaded onto the working plate. The backlight assembly is inspected by rotating the cover to fix the backlight assembly, applying power to the backlight assembly, inspecting a first on-off state of the main part of the backlight assembly, rotating the working plate, and inspecting a second on-off state of the sub part of the backlight assembly.

According to various embodiments of the present invention, display devices can be manufactured using a rotatable jig, thereby improving assembly efficiency, reducing defective products, and improving production.

### BRIEF DESCRIPTION OF THE DRAWINGS

The above and other features and advantage points of the present invention, including exemplary embodiments thereof, will become apparent by referring to the following detailed description and the accompanying drawings, in which:

FIG. 1 is a perspective view illustrating a jig in accordance with an exemplary embodiment of the present invention;

FIG. 2 is a flow chart illustrating a method of manufacturing a display device in accordance with an exemplary embodiment of the present invention;

FIG. 3 is an exploded perspective view illustrating a display device manufactured by the method of FIG. 2;

FIG. 4 is a perspective view illustrating a step of installing a main panel in the method of FIG. 2;

FIG. 5 is a perspective view illustrating a step of rotating a working plate in the method of FIG. 2;

FIG. 6 is a flow chart illustrating a method of manufacturing a display device using a jig in accordance with another exemplary embodiment of the present invention;

FIG. 7 is a flow chart illustrating a step of inspecting an on-off state in the method of FIG. 6; and

FIG. 8 is a perspective view illustrating the step of inspecting the on-off state in the method of FIG. 7.

### DETAILED DESCRIPTION OF THE EMBODIMENTS

The present invention will be described more fully hereinafter with reference to the accompanying drawings, in which embodiments of the invention are shown. This invention may, however, be embodied in many different forms and should not be construed as limited to the embodiments set forth herein. The embodiments are provided for purposes of example only, and not for purposes of limitation. Like reference numerals refer to similar or identical elements throughout.

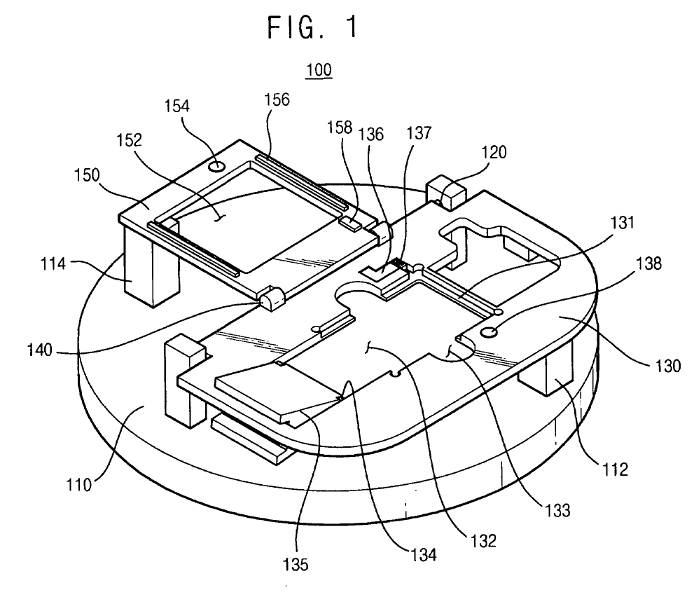

FIG. 1 is a perspective view illustrating a jig in accordance with an exemplary embodiment of the present invention.

Referring to FIG. 1, a jig 100 includes a stage 110, a first hinge part 120, a working plate 130, a second hinge part 140, and a cover 150.

The stage 110 may, for example, have a circular plate shape. Alternatively, the stage 110 may have various shapes, such as a rectangular plate shape. The stage 110 may be slanted at a predetermined angle for workers' convenience. The stage 110 may be rotated along a circumferential direction thereof by a rotating means such as a bearing. For example, in one embodiment, the stage 110 can be rotated by about 45°. Thus, the stage 110 may be rotated during an assembly process. A first support 112 and a second support 114 are disposed over the stage 110 to support the working plate 130 and the cover 150, respectively.

The first hinge part 120 is installed across a central portion of the stage 110. The first hinge part 120 is disposed over the stage 110, and a first hinged axis of the first hinge part 120 is disposed parallel with an upper face of the stage 110.

The working plate 130 is joined to the first hinge part 120 to be rotated with respect to the first hinge part 120. The working plate 130 includes a receiving part 131 for receiving an object at a central portion of the working plate 130. A first opening 132 is formed on the working plate 130 to expose the object received by the receiving part 131. A second opening 133 is formed on the working plate 130. The object may be loaded onto the working plate 130 and unloaded from the working plate 130 through the second opening 133. The assembly process may be easily performed using the second opening 133 when the object is loaded onto the working plate 130 or unloaded from the working plate 130.

The working plate 130 further includes a third hinge part 134 at a side of the first opening 132 and a supporting member 135 joined to the third hinge part 134. The supporting member 135 is rotated within the first opening 132 at a predetermined angle with respect to the third hinge part 134.

The working plate 130 further includes a power applying part 136 for applying power to the object received by the receiving part 131. The power applying part 136 includes a power contacting part 137. The power contacting part 137 is electrically connected with a power terminal of the object when the object is received by the working plate 130 to be fixed by the cover 150.

The second hinge part 140 is installed at a side of the working plate 130 corresponding to the receiving part 131. A second hinged axis of the second hinge part 140 is substantially parallel with an upper face of the working plate 130.

The cover 150 is joined to the second hinge part 140 to be rotated with respect to the second hinge part 140. The cover 150 is rotated with respect to the second hinge part 140 and then joined to the working plate 130 so as to fix the object received by the working plate 130. A third opening 152 is formed on the cover 150 to expose the object received by the working plate 130.

The cover 150 further includes a joining member 154 to join the cover 150 to the working plate 130. The joining member 154 may, for example, include a first magnetic material so that the cover 150 and the working plate 130 may be joined to each other by a magnetic force. The working plate 130 further includes a joining part 138 to join to the joining member 154. The joining part 138 may include a second magnetic material corresponding to the first magnetic material. Alternatively, the cover 150 and the working plate 130 may be joined to each other through a mechanical structure.

The cover 150 further includes a buffing member 156 formed on a surface making contact with the working plate 130. The buffing member 156 prevents the object from being damaged when the cover 150 is joined to the working plate 130. The buffing member 156 may include a flexible and/or elastic material. For example, in one embodiment the buffing member 156 includes silicon.

The cover 150 further includes a power fixing part 158 formed thereon. The power fixing part 158 corresponds to the power contacting part 137 of the working plate 130. By the power fixing part 158, the power terminal of the object makes safe contact with the power contacting part 137 when the cover 150 is joined to the working plate 130. Thus, the power fixing part 158 may preferably include a flexible and/or elastic material. For example, in one embodiment the power fixing part 158 includes silicon.

Hereinafter, a method of manufacturing a display device using the jig 100 will be described in detail.

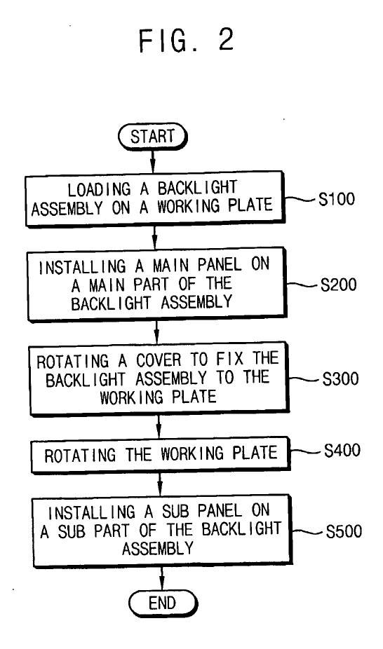

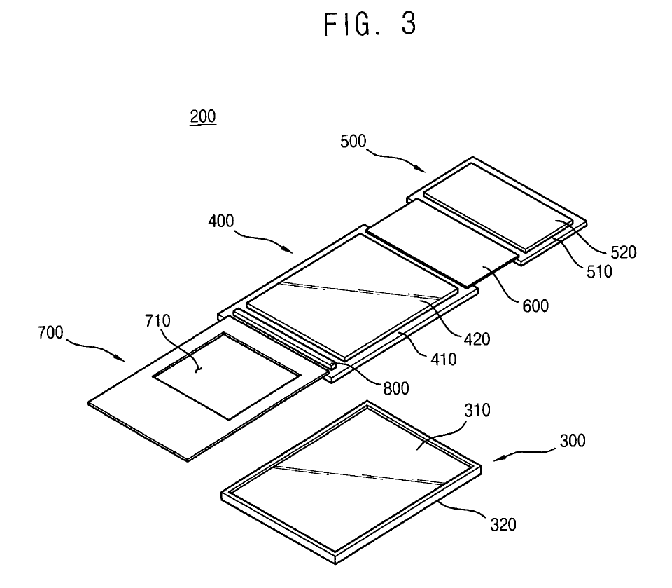

FIG. 2 is a flow chart illustrating a method of manufacturing a display device in accordance with an exemplary embodiment of the present invention. FIG. 3 is an exploded perspective view illustrating a display device manufactured by the method of FIG. 2.

Referring to FIGS. 1 to 3, a method of manufacturing a display device 200 using the jig 100 includes loading a backlight assembly 300 on the working plate 130 of the jig 100 in step S100, installing a main panel 400 on a main part 310 of the backlight assembly 300 in step S200, rotating the cover 150 to fix the backlight assembly 300 to the working plate 130 in step S300, rotating the working plate 130 in step S400, and installing a sub panel 500 on a sub part 320 of the backlight assembly 300 in step S500.

The display device 200 includes the backlight assembly 300 which emits a light in two directions, the main panel 400 installed on the main part 310 of the backlight assembly 300, and the sub panel 500 installed on the sub part 320 of the backlight assembly 300.

The backlight assembly 300 emits a first light from the main part 310 and a second light from the sub part 320 opposite to the main part 310. Amounts of the first and second lights may be variable. For example, in one embodiment, 70% of the total light emitted from the backlight assembly 300 is emitted from the main part 310 and 30% is emitted from the sub part 320. As a result, the majority of the light emitted from the backlight assembly 300 is provided to the main panel 400,

The main panel 400 is disposed on the main part 310 of the backlight assembly 300 and displays a main image using the first light provided from the main part 310. The main panel 400 includes a first lower substrate 410, a first upper lo substrate 420 corresponding to the first lower substrate 410, and a first liquid crystal layer (not shown) between the first lower substrate 410 and the first upper substrate 420.

The sub panel 500 is disposed on the sub part 320 of the backlight assembly 300, and displays a sub image using the second light provided from the sub part 320. The sub panel 500 includes a second lower substrate 510, a second upper substrate 520 corresponding to the second lower substrate 510, and a second liquid crystal layer (not shown) between the second lower substrate 510 and the second upper substrate 520. The sub panel 500 has a size smaller than the main panel 400.

The display device 200 further includes a flexible circuit film 600 connecting the main and sub panels 400 and 500 with each other. The sub panel 500 may be disposed on the sub part 320 of the backlight assembly 300 by bending the flexible circuit film 600.

The display device 2 0 further includes a flexible printed circuit (FPC) 700 driving the main and sub panels 400 and 500, and a driver chip 800.

The FPC 700 is connected with an end portion of the first lower substrate 410. The FPC 700 outputs an initial image signal and an initial control signal. The initial image signal and the initial control signal drive the main panel 400 and the sub panel 500. The FPC 700 is bent to be disposed on the sub part 320 of the backlight assembly 300. A fourth opening 710 is formed on the FPC 700 to expose the sub panel 500.

The driver chip 800 is disposed adjacent to the end portion of the first lower substrate 410 with which the FPC 700 is connected. The driver chip 800 outputs various signals driving the main and sub panels 400 and 500 in response to the initial image signal and the initial control signal. The signals outputted from the driver chip 800 include a main image signal, a sub image signal, a main gate signal, a sub gate signal, and other signals as may be appropriate. The main panel 400 displays the main image using the main image signal and the main gate signal outputted from the driver chip 800. The sub panel 500 displays the sub image using the sub image signal and the sub gate signal outputted from the driver chip 800. The sub image signal and the sub gate signal are applied to the sub panel 500 by the flexible circuit film 600.

In step S100, the backlight assembly 300 is loaded onto the receiving part 131 of the working plate 130, so that the main part 310 is facing upward.

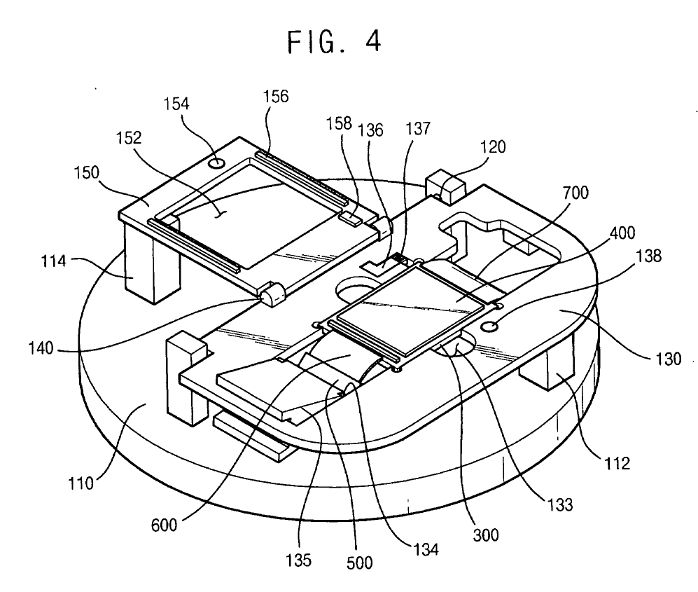

FIG. 4 is a perspective view illustrating the step of installing a main panel in the method of FIG. 2.

Referring to FIGS. 2 and 4, in step S200, main panel 400 is installed on the main part 310 of the backlight assembly 300. The main panel 400 is fixed to the main part 310 using an adhesive such as a double-sided adhesive tape formed on a peripheral portion of the main part 310. The sub panel 500 and the FPC 700 are connected with both sides of the main panel 400, respectively. The sub panel 500 is disposed under the supporting member 135 by bending the flexible circuit film 600.

In step S300, the cover 150 is rotated with respect to the second hinge part 140 to be fixed to the working plate 130. The joining member 154 of the cover 150 is joined to the joining part 138 of the working plate 130 by a magnetic force. The buffing member 156 of the cover 150 smoothly pushes both end portions of the main panel 400. The backlight assembly 300 is safely fixed to main panel 400 by joining the cover 150 to the working plate 130.

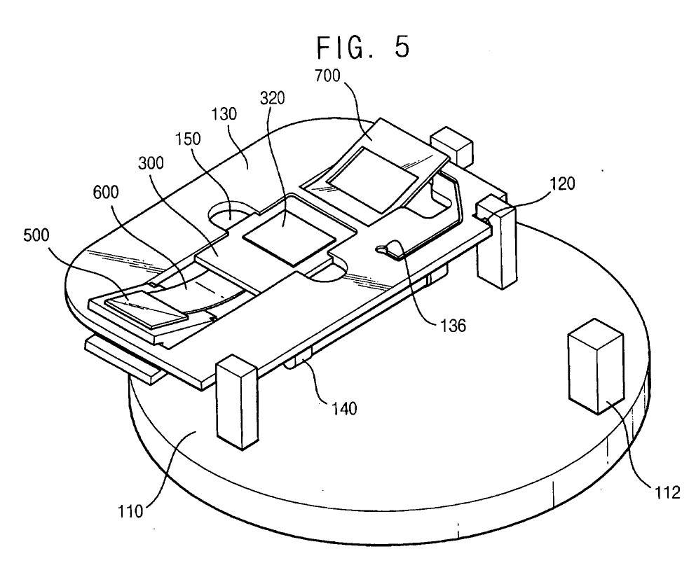

FIG. 5 is a perspective view illustrating a step of rotating a working plate in the method of FIG. 2.

Referring to FIGS. 2 and 5, in step S400, the working plate 130 is rotated with respect to the first hinge part 120. The rotated working plate 130 is supported by the second support 114. After rotating the working plate 130, the sub part 320 of the backlight assembly 300 is exposed through the first opening 132. The sub panel 500 is disposed on and supported by the supporting member 135.

In step S500, the sub panel 500 is installed on the sub part 320 of the backlight assembly 300 by bending the flexible circuit film 600. The sub panel 500 is fixed to the sub part 320 using an adhesive such as a double-sided adhesive tape formed on a peripheral portion of the sub part 320. Following step S500, the method of FIG. 2 ends.

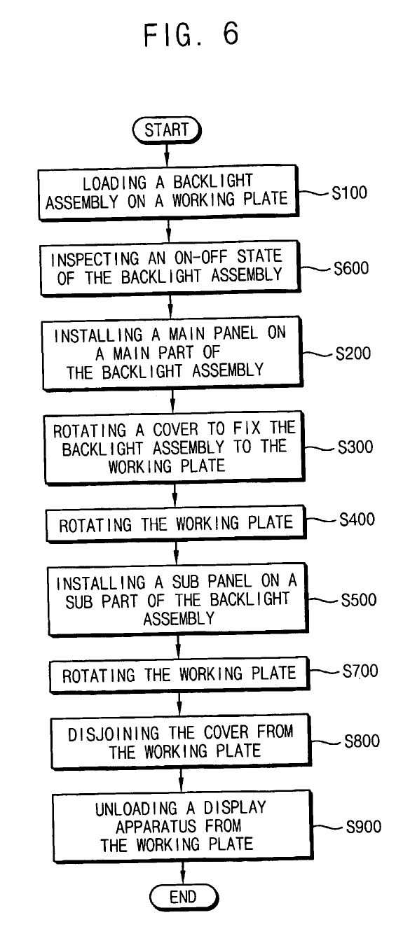

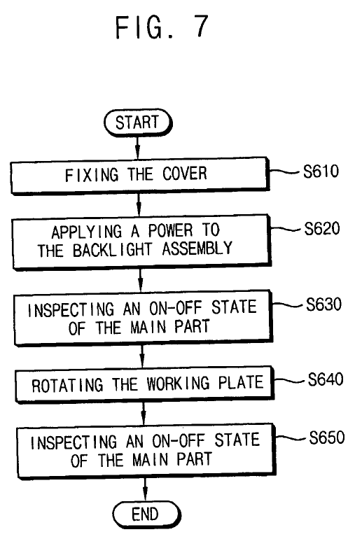

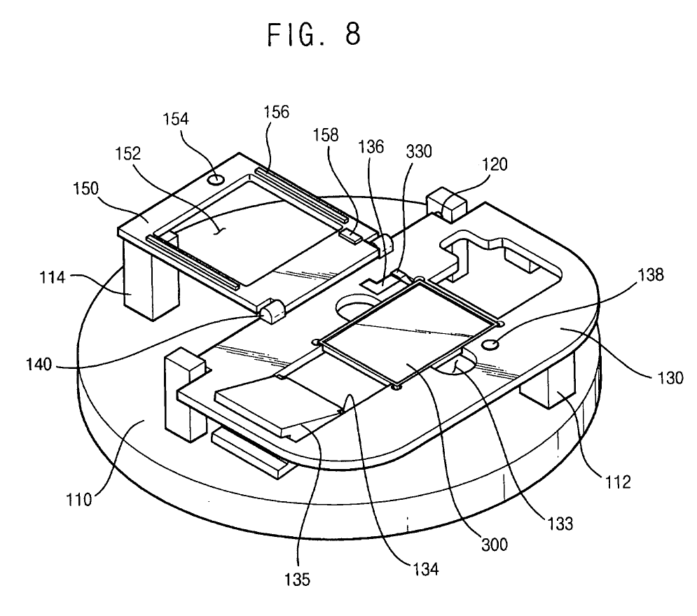

FIG. 6 is a flow chart illustrating a method of manufacturing a display device using a jig in accordance with another exemplary embodiment of the present invention. FIG. 7 is a flow chart illustrating a step of inspecting an on-off state in the method of FIG. 6. FIG. 8 is a perspective view illustrating the step of inspecting the on-off state in the method of FIG. 7.

Referring to FIGS. 6 to 8, a method of manufacturing a display device further includes inspecting an on-off state of the backlight assembly 300 in step S600. Step S600 is performed between loading the backlight assembly 300 in step S100 and installing the main panel 400 in step S200.

The on-off state of the backlight assembly in step S600 is inspected by fixing the cover 150 in step S610, applying a power to the backlight assembly 300 in step S620, inspecting a first on-off state of the main part 310 in step S630, rotating the working plate 130 in step S640, and inspecting a second on-off state of the sub part 320 in step S650.

In step S610, the cover 150 is rotated with respect to the second hinge part 140 to be joined to the working plate 130 so as to fix the backlight assembly 300 loaded on the working plate 130. The joining member 154 of the cover 150 is connected with the joining part 138 of the working plate 130 by a magnetic force. The buffing member 156 of the cover 150 smoothly pushes both end portions of the backlight assembly 300. The power fixing part 158 pushes a power terminal 330 of the backlight assembly 300 so that the power contacting part 137 may safely contact the power terminal 330 when the cover 150 is joined to the working plate 130.

In step S620, power is applied to the backlight assembly 300 to drive the backlight assembly 300. The power generated from an external power generating part (not shown) is applied to the backlight assembly 300 through the power applying part 136 of the working plate 130. The backlight assembly 300 generates light in response to the applied power.

In step S630, the first on-off state of the main part 310 of the backlight assembly 300 is inspected to determine whether it is regularly turned on and whether impurities are present.

In step S640, the working plate 130 is rotated with respect to the first hinge part 120 to expose the sub part 320 of the backlight assembly 300.

In step S650, the second on-off state of the sub part 320 of the backlight assembly 300 is inspected to determine whether it is regularly turned on and whether impurities are present.

It will be appreciated that steps S200 through S500 of the method of FIG. 6, are substantially identical to like-identified steps of the method shown in FIG. 2.

The method of FIG. 6 further includes rotating the working plate 130 in step S700, disjoining the cover 150 from the working plate 130 in step S800, and unloading the display device 200 from the working plate 130 in step S900.

In step S700, the working plate 130 previously rotated toward a first side for installing the sub panel 500 is rotated toward a second side with respect to the first hinge part 120 so that the cover 150 may be exposed.

In step S800, the cover 150 is disjoined from the working plate 130 so that the completely assembled display device 200 may be unloaded from the jig 100. The cover 150 is rotated from the second side toward the first side with respect to the second hinge part 140 to be disjoined from the working plate 130. The cover 150 is joined to the working plate 130 by a magnetic force, so that the cover 150 may be easily disjoined from the working plate 130 with little force.

In step S900, the completely assembled display device 200 is unloaded from the working plate 130. The unloading may be easily performed using the second opening 133 of the working plate 130. Following step S900, the method of FIG. 6 ends.

It will be appreciated that embodiments of the present invention can permit a main panel and a sub panel to be installed on a display device using only one rotatable jig thereby reducing assembly time of the display device, increasing assembly efficiency, and improving production.

In addition, a backlight assembly of the display device need not be disjoined from the jig when assembling the main panel and the sub panel, or when inspecting on-off states thereof. As a result, deterioration of a flexible circuit film due to workers' frequent handling of the backlight assembly can be prevented, thereby improving display device production.

Although exemplary embodiments of the present invention have been described, it will be understood that the present invention is not be limited to these exemplary embodiments. Various changes and modifications can be made by those skilled in the art within the spirit and scope of the present invention as hereinafter claimed.

What is claimed is:

1. A jig for manufacturing a display device, the jig comprising:
a stage;
a first hinge part disposed over the stage, the first hinge part being substantially parallel with the stage;
a working plate joined to the first hinge part, the working plate including a receiving part to receive an object;
a second hinge part at a side of the working plate, the second hinge part being substantially parallel with the working plate; and
a cover joined to the second hinge part.

2. The jig of claim 1, wherein the stage is adapted to be rotated along a circumferential direction thereof.

3. The jig of claim 1, wherein the working plate is adapted to be rotated with respect to the first hinge part.

4. The jig of claim 1, further comprising a first opening formed on the working plate to expose the object received by the receiving part.

5. The jig of claim 4, further comprising a second opening formed on the working plate, wherein the second opening is adapted for use in loading the object onto the working plate and unloading the object from the working plate.

6. The jig of claim 4, wherein the working plate further includes:
a third hinge part; and
a supporting member joined to the third hinge part to be rotated within the first opening with respect to the third hinge part.

7. The jig of claim 1, wherein the working plate further includes a power applying part configured to apply power to the object.

8. The jig of claim 1, wherein the cover is adapted to be rotated with respect to the second hinge part.

9. The jig of claim 1, further comprising a third opening formed on the cover to expose the object received by the working plate.

10. The jig of claim 1, wherein the cover includes a joining member configured to join the cover to the working plate.

11. The jig of claim 10, wherein the joining member includes a magnetic material.

12. The jig of claim 1, wherein the cover includes a buffing member formed on a surface contacting the working plate.

13. A method of manufacturing a display device using a jig, comprising:
loading a backlight assembly onto a working plate of the jig;
installing a main panel on a main part of the backlight assembly;
rotating a cover joined to the working plate to fix the backlight assembly to the working plate;
rotating the working plate; and
installing a sub panel on a sub part of the backlight assembly.

14. The method of claim 13, wherein the jig comprises:
a stage;
a first hinge part disposed over the stage, the first hinge part being substantially parallel with the stage;
a working plate joined to the first hinge part, the working plate including a receiving part to receive an object;
a second hinge part at a side of the working plate, the second hinge part being substantially parallel with the working plate; and
a cover joined to the second hinge part.

15. The method of claim 14, wherein the working plate further includes:
a third hinge part; and
a supporting member joined to the third hinge part to support the sub panel.

16. The method of claim 13, wherein the main panel and the sub panel are connected with each other by a flexible circuit film.

17. The method of claim 13, further comprising inspecting the backlight assembly loaded onto the working plate.

18. The method of claim 17, wherein the backlight assembly is inspected by:
rotating the cover to fix the backlight assembly;
applying power to the backlight assembly;
inspecting a first on-off state of the main part of the backlight assembly;
rotating the working plate; and
inspecting a second on-off state of the sub part of the backlight assembly.

19. The method of claim 13, further comprising:
rotating the working plate;
rotating the cover; and
unloading the display device from the working plate,
after installing the sub panel on the sub part of the backlight assembly.
